(19) United States
(12) Patent Application Publication
(10) Pub. No.: US 2015/0097759 A1
(43) Pub. Date: Apr. 9, 2015

(54) WEARABLE APPARATUS FOR ACCESSING MEDIA CONTENT IN MULTIPLE OPERATING MODES AND METHOD OF USE THEREOF

(71) Applicants: Allan Thomas Evans, Ann Arbor, MI (US); Edward Tang, Ann Arbor, MI (US)

(72) Inventors: Allan Thomas Evans, Ann Arbor, MI (US); Edward Tang, Ann Arbor, MI (US)

(21) Appl. No.: 14/047,032

(22) Filed: Oct. 7, 2013

(51) Int. Cl. H04R 1/02; G02B 27/01

(52) U.S. Cl. CPC H04R 1/028; G02B 27/017; H04R 2499/15; H04R 2499/11
USPC 345/8

(57) ABSTRACT

An apparatus that can be worn on the head of the user that can operate in a variety of different modes including an audio-only mode and an audio-visual mode. A wide variety of different user controls can be utilized to allow users to make a wide variety of different adjustments to the functionality of the apparatus.

### BACKGROUND OF THE INVENTION

The invention is an apparatus and method for accessing media content (collectively the “apparatus”). More specifically, the apparatus provides for being worn on the head of a user while accessing media content in multiple operating modes, such as audio-only or audio-visual.

In 2013, the ability of an individual to access media content of their choosing has never been greater. The home entertainment industry has been transformed by technical and business developments in the information technology industry. Hardcover book sales are outpaced by e-book sales. More music is bought online as MP3 files that on CDs. Movies, television shows, and other video content are increasingly viewed through online streaming services or as downloaded content.

In the world of media content, the consumer is king and consumers are growing accustomed to accessing whatever content they want, whenever they want. The ability of a human being to access content has never been greater. As media content becomes easier and easier to access, providers of media content find increasing ways to make such content available to users.

Coinciding with the trend of ever increasing media options is the increasing reliance on general purpose computing devices as replacements for traditional consumer electronics devices. General purpose computers are replacing the use of DVD players, radios, CD players, and other application-specific consumer electronics products.

This evolution of technology and resulting explosion in consumer options is not limited to the home. Mobile computing in the form of smart phones, tablet computers, and other devices has led to an explosion in the ability of individuals to access the media content of their choosing while on the go. Airplane travelers in 2013 are far more likely to be interested in playing their own personally selected media content on a mobile computing device than they are to view a film selected to be suitable for the broad range of passengers on a transatlantic flight.

Despite the rapid expansion of options in the context of types of media players and different ways to deliver media content to media players, there are aspects of the media consumption experience that have been substantially unchanged for many years. The speed of innovation is uneven, and there are aspects of the media consumption experience that are remarkably unchanged over many years. One such area in the context of personalized media consumption is the device actually worn by the user—the headphones used to access audio content.

While the appearance of headphones have undergone visually superficial changes over the years, from the standpoint of functionality there have been few changes. The headphones used with personal audio players such as the SONY® WALKMAN® that were ubiquitous in the 1980s perform the same function as headphones with the MP3 players and smart phones of 2013. In most instances, a 1980s headphone can actually be used in conjunction with a 2013 media player.

Headphones are limited to audio content for reasons grounded in history, inertia, a lack of interest reinventing the wheel, and an affirmative teaching away from more expansive functionality by the prior art. The technical capability to display visual content on a small mobile screen of a quality that people could enjoy is a relatively recent technical capability. The capability to access video content remotely through small lightweight devices is also a relatively recent technical capability. The prior art does not offer consumers the option of a wearable apparatus that includes the audio capabilities of conventional headphones coupled with a capability of viewing video and other visual content possessing distinctive operating modes for audio-visual and audio-only content. The prior art neither discloses nor suggests the capability of headphones to operate in both an audio-only operating mode as well as in an audio-visual operating mode. The prior art affirmatively teaches away from an integrated apparatus worn on the head of users that is capable of delivering visual as well as audio content.

Consumers and manufacturers alike consider the externalities of sound to be substantially different than the externalities of vision. Sound generated from a user's smart phone on a crowded train or in a public library is looked at differently than the visual images emanating from that same smart phone in those same contexts. Sound content is intrusive, disturbing, and rude while the personal playing of visual content in those same contexts is not.

Generally speaking, manufacturers have no interest in developing wearable screens for the purpose of media consumption. Such visual displays would be redundant with the display screens included in the smart phone, tablet, or other form of mobile computing device. Moreover, conventional wisdom in the industry suggests that consumers would not embrace such functionality. A common word used by consumers in reaction to the GOOGLE GLASS® eyewear computer is “creepy”. Moreover, the GOOGLE GLASS® product is not intended to function as a media player and it does not serve as a viable alternative for conventional headphones. Adding high quality sound capabilities and multiple operating modes such as audio-only and audio-visual to such eyewear products is contrary to the goals of a lightweight product that consumers would contemplate using.

There is no integrated wearable headphone device that is also capable of selectively displaying visual content. While the phrase “visual headphones” is a common term, the term as used in 2013 refers to conventional headphones that visually display metadata about the audio content being listened to. The prior art does not teach or even suggest that a single wearable device that includes both a visual display and an audio speaker—a device that can operate in both audio-only and audio-visual operating modes. There is currently no suggestion in the prior art such a capability is a desirable. To the contrary, the conventional wisdom of consumers and manufacturers is that headgear is obtrusive looking, and thus only appropriate for use in the home, a location where audio privacy is not a factor. Conversely, audio privacy is necessary only when out in public, and in such locations users want audio equipment to be as visually unobtrusive as possible.

### SUMMARY OF THE INVENTION

The invention is an apparatus and method for accessing media content (collectively the “apparatus”). More specifically, the apparatus provides for being worn on the head of a user while accessing media content in multiple operating modes, such as audio-only or audio-visual. The range of media content can include movies, television programs, music, e-books, still frame photograph, slide shows, video games, and virtually any other combination of visual and/or audio elements.

The apparatus can be embodiment in a wide range of different devices. The apparatus can be embodied in any configuration of headgear components capable of including a display screen as well as one or more speakers. The original inspiration for the apparatus pertained to a headphones apparatus that included a moveable display screen capable of displaying visual content coinciding with the audio content accessed through the headphones. The apparatus could also be embodied in the form of glasses, a baseball cap with a display screen that flips down from the bill of the cap, a helmet, and many other types of headgear worn by human beings.

The apparatus can operate in a variety of different operating modes, including but not limited to an audio-only mode where the user is exposed only to audio content and an audio-visual mode where the user has access to both audio and visual content. When in audio-visual mode, a display screen is used to access visual content while one or more speakers are used to access audio content. When in an audio-only mode, the display screen can be disabled and/or be moved away from the eyes of the user even while the apparatus remains securely positioned on the head of the user.

Different embodiments of the apparatus can utilize different techniques for changing from one operating mode to another operating mode. For example, in one embodiment of the apparatus, the user can move the display screen into a position (such as directly in front of the user's eyes) that is associated with an audio-visual operating mode or into a position (such as above the user's head) that is associated with an audio-only operating mode. A wide range of different user controls can be used to trigger changes in operating modes as well as to make adjustments to the manner in which the apparatus functions.

Some embodiments of the apparatus can include the ability of a user to define customizable preferences that can impact the way in which the apparatus functions with respect to that user. Some embodiments of the apparatus can include the media playing capacity directly in the apparatus, while in other embodiments the apparatus will need to be hooked up (through either wired or wireless connections) to an external media player device.

### BRIEF DESCRIPTION OF THE DRAWINGS

Many features and inventive aspects of the system are illustrated in the following drawings:

FIG. 1a is a block diagram illustrating an example of a user interacting with media content using an embodiment of the apparatus that includes a display and a speaker, the different operating modes that can be incorporated into an embodiment of the apparatus, and the different types of media content that can be accessed by an embodiment of the apparatus.

FIG. 1b is environmental view illustrating an example of a front view of a user wearing an embodiment of the apparatus.

FIG. 1c is an environmental view illustrating an example of a perspective view of a user wearing an embodiment of the apparatus.

FIG. 1d is a flow chart diagram illustrating an example of a process for using an embodiment of the apparatus to access media content.

FIG. 1e is a block diagram illustrating an example of some of the components that can be included as part of an embodiment of the apparatus, including the different types of user controls.

FIG. 2 is a block diagram illustrating an example of various components that can be included in some embodiments of the apparatus.

FIG. 3 is a hierarchy diagram illustrating an example of different types of adjustments that can be made with one or more user controls.

FIG. 4a is an environmental diagram illustrating an example of a side view of a user wearing an embodiment of the apparatus.

FIG. 4b is an environmental diagram illustrating an example of a front view of a user wearing an embodiment of the apparatus that includes a display that is only attached to the apparatus on one side.

FIG. 4c is an environmental diagram illustrating an example of a perspective view of a user wearing an embodiment of the apparatus that includes a display that is only attached to the apparatus on one side.

FIG. 4d is an environmental diagram illustrating an example of a side view of a user wearing an embodiment of the apparatus that includes a display that is only attached to the apparatus on one side.

FIG. 4e is an environmental diagram illustrating an example of a perspective view of a user wearing an embodiment of the apparatus that allows the display to be rotated upwards when the apparatus is not displaying visual content.

FIG. 4f is an environmental diagram illustrating an example of a perspective view of a user wearing an embodiment of the apparatus with the display in a position that does not block the eyes of the user.

FIG. 5a is a diagram illustrating a perspective view of different components of the apparatus, including various adjustments that can be made to the apparatus.

FIG. 5b is a diagram illustrating a perspective view of springs allowing a speaker to move along a headband.

FIG. 5c is a diagram illustrating a perspective view of certain components of the apparatus.

FIG. 6a is a process flow diagram illustrating an example of a user accessing media content first in an audio-visual mode and then in an audio-only mode.

FIG. 6b is a process flow diagram illustrating an example of a user accessing media content first in an audio-only mode and then in an audio-visual mode.

### DETAILED DESCRIPTION

The invention is an apparatus and method for accessing media content (collectively the “apparatus”). More specifically, the apparatus provides for being worn on the head of a user while accessing media content in multiple operating modes, such as audio-only or audio-visual.

### I. OVERVIEW

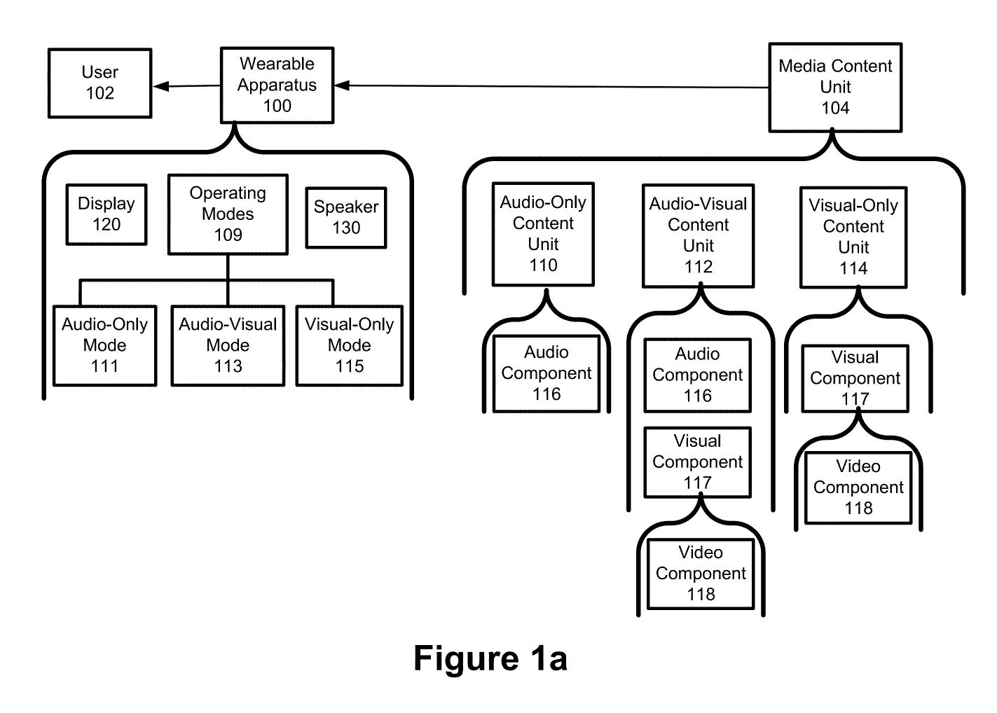

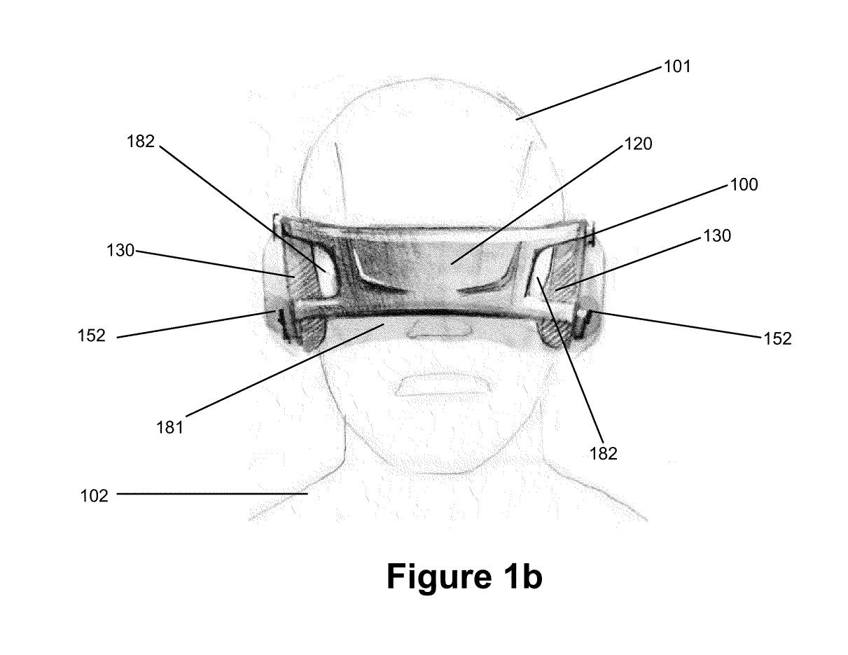

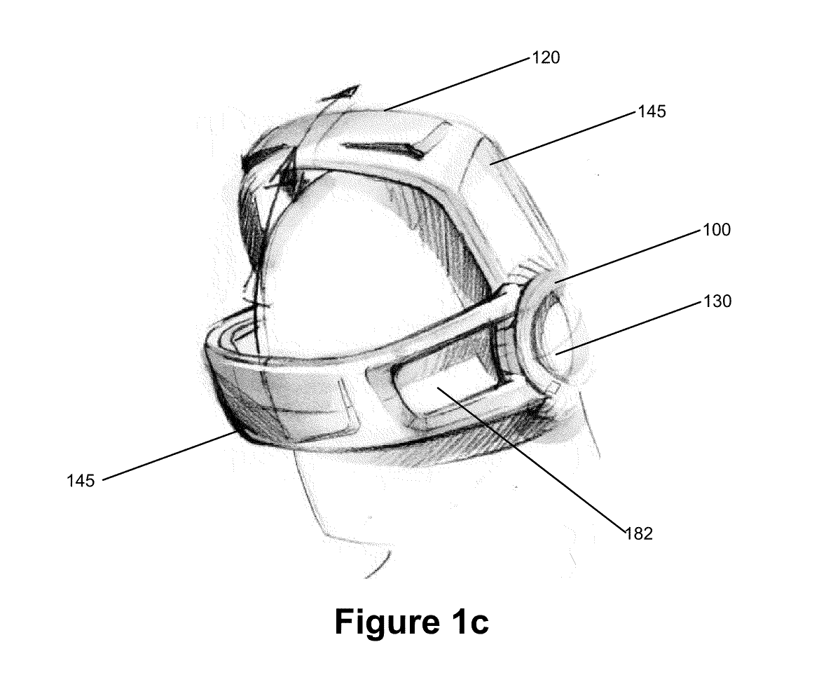

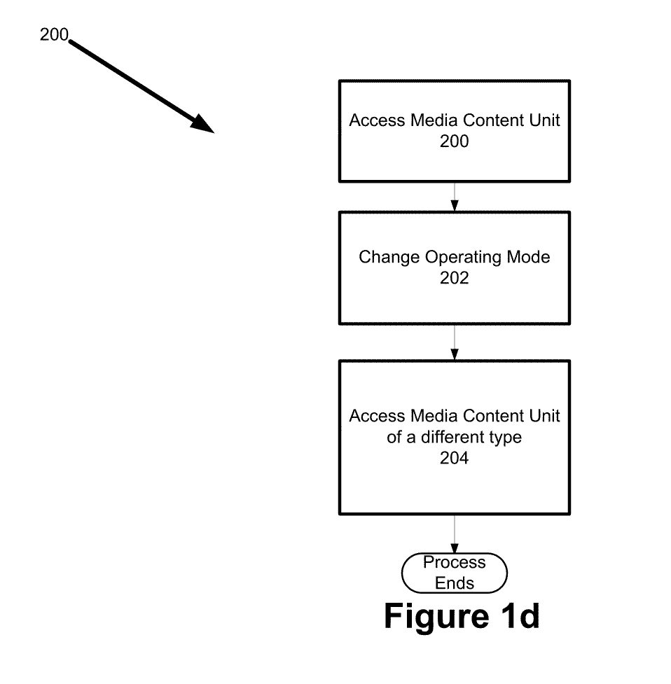

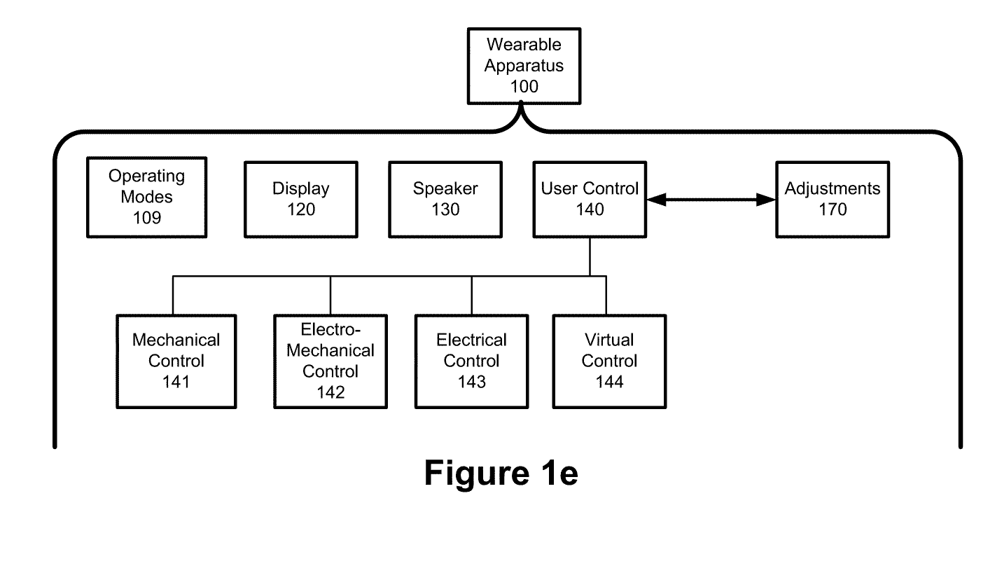

As illustrated in FIG. 1a, an apparatus 100 allows a user 102 to access a wide variety of different types of media content units 104.

A. Media Content Unit

The apparatus 100 can be used to access a wide variety of different types of media content units 104. A media content unit 104 is potentially any type or form of media that has an audio component 116 and/or a visual component 117, such as a video component 118. Examples of types of content include movies, television programs, music, e-books, online magazines, music videos, concert videos, video games, slide show presentations, still photographs, drawings, paintings, individual graphical images, short audio clips, short video clips, Internet web sites, graphical user interfaces, and any other form of audio and/or visual content. Media content units 104 can potentially be short “atomic” level clips of content, an extended anthology of content (such as a series of albums, movies, or television programs), or any level in between those two extremes.

A human being has 5 senses, the sense the sight, sound, touch, taste, and smell. In most contexts, media content unit 104 will involve an audio component 116 and/or a visual component 117, including but not limited to a video component 118. In some instances, content may also involve the sense of touch (such as vibrations) or even smell. As technologies develop and provide for additional types of content that can be accessed by users 102, such technologies can be incorporated into the apparatus 100.

1. Audio Component

An audio component 116 is an aspect of a media content unit 104 that pertains to the sense of sound. Audio components 116 can be found in audio-only content units 110 as well as in audio-visual content units 112. Common examples of an audio component 116 include music, human speech, and sound effects.

2. Visual Component

A visual component 117 is an aspect of a media content unit 104 that pertains to the sense of sight. Visual components 117 can be found in audio-visual content units 112 and visual-only content units 114. Common examples of visual components 117 include text and/or, graphics from an e-book, online magazine, website, video game presentation, slide show, etc. A video component 118 is a subcategory of visual components 117.

3. Video Component

A visual component 117 is a type of visual component 117 where the various images are played for the user 102 in a sequence without specific prompting from the user 102. Video components 117 can be found in audio-visual content units 112 as well as visual-only content units 114. Examples of video components include movies, television programs, many video games, and automated presentation slide shows.

B. User

A wide variety of different users 102 can potentially benefit from accessing media content units 104 through the apparatus 100. In many embodiments of the apparatus 100, the user 102 is a human being wearing the apparatus 100 on a head 101 as illustrated in FIG. 1 b. The inception of the apparatus 102 was inspired by the desire to provide an improved way in which human beings could better experience media entertainment while traveling. However, the apparatus 100 is neither limited to use for travelers nor limited to the human beings. The apparatus 100 can be used by adults and children in the home, on the road, in schools, at work, and in many different contexts. The apparatus 100 can function as a wearable computer monitor for business, technical, medical, and other non-entertainment purposes. Users 102 of the apparatus 102 can potentially include animals such as pets as well as robots or other man-made devices.

C. The Apparatus

Returning to FIG. 1a, the apparatus 100 can use a display 120 for accessing visual content (i.e. a visual component 117 of the media content unit 104) and a speaker 130 for accessing audio content (i.e. an audio component 116 of the media content unit 104). The apparatus 100 can operate in a variety of different operating modes 109, such as an audio-only mode 111 when an audio-only content unit 110 is being played and an audio-visual model 113 when an audio-visual content unit 112 is being played.

The apparatus 100 can serve as a single device used in conjunction with a wide variety of different media player devices and a wide variety of different types of media content. Unlike conventional headphones, the apparatus 100 provides users 102 with the ability to access the visual component 117 such as a video component 118 of a media content unit 104. Unlike the conventional screens of a computer, such as a smart phone or a tablet, use of the display, 120 in the apparatus 100 to access visual content can ensure privacy with respect to what is viewed by the user 102.

In some embodiments of the apparatus 100, the various component parts of the apparatus 100 are designed to be removable and interchanged by users 102. In other embodiments, the apparatus 100 is intended to be a permanently integrated device that is not subject to disassembly by users 102.

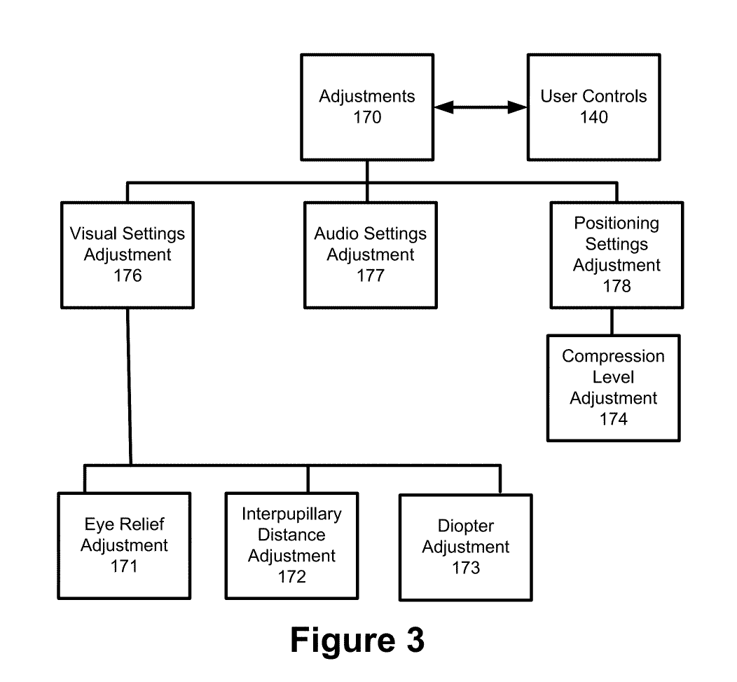

As illustrated in FIG. 1e, the apparatus 100 can include a wide variety of different types of user controls 140 to trigger a wide variety of different types of adjustments 170 as illustrated in FIG. 3, as well as to potentially change between different operating states 109.

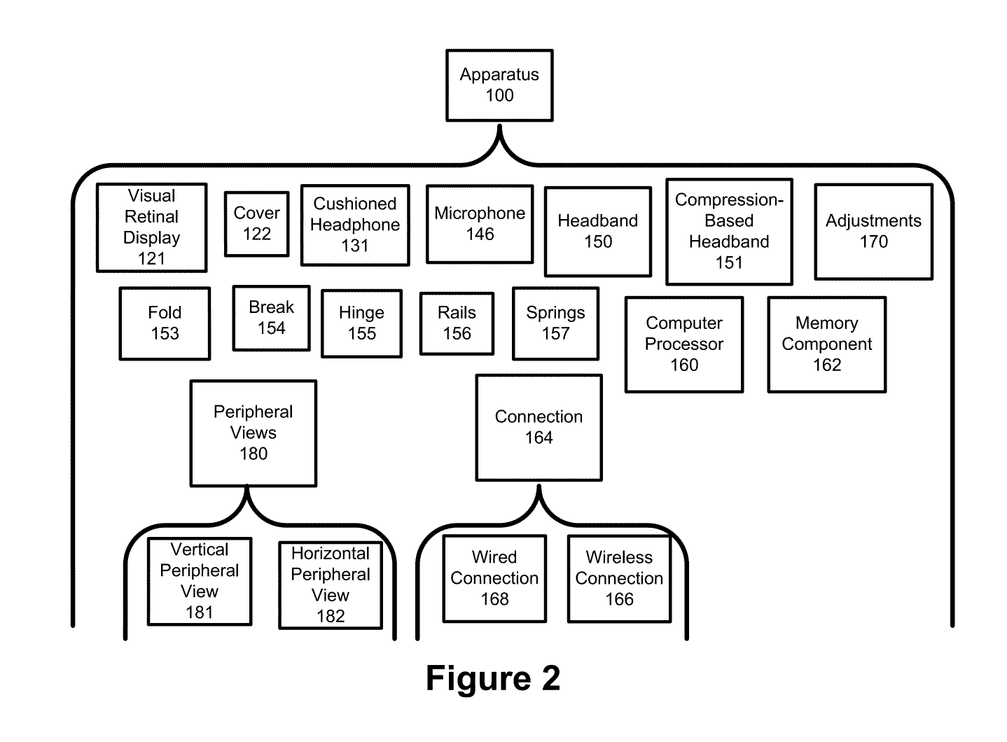

In some embodiments of the apparatus 102, the media content unit 104 being accessed by the user 102 is played on a media player device that is separate and distinct from the apparatus 100. As illustrated in FIG. 2, the apparatus 100 can utilize a connection 164 whether a wireless connection 166 or a wired connection 164 to communicate with external devices as well as for other components in the apparatus 100. This can occur over a connection 164, whether wireless 166 or wired 168 (see FIG. 2) between the media player device and the apparatus 100. In other embodiments of the apparatus 100, the apparatus 100 is itself the media player. For example, the apparatus 100 can include a computer processor 160, a memory component 162, and other components necessary to function as a media player. Thus, in some embodiments of the apparatus 100, no connection 164 with an external source of content is required.

1. Different Embodiments

The apparatus 100 can be implemented in a wide variety of different embodiments that differ from each other significantly in terms of aesthetic appearance, product type, and product style. Different embodiments of the apparatus 100 can involve different user controls 140 and different mechanisms by which to change from one operating mode 109 to another operating mode 109.

a. Headphone Embodiments

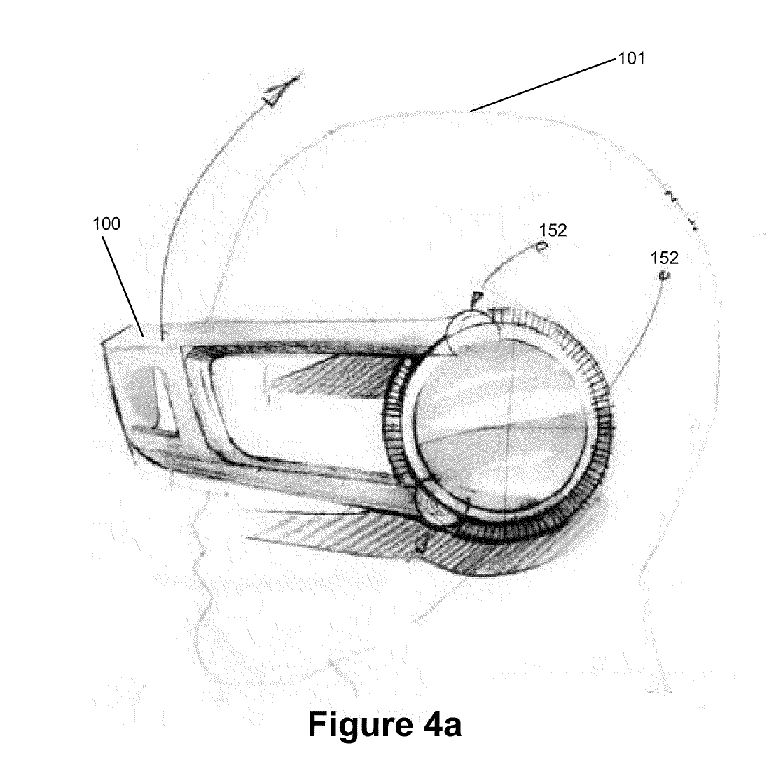

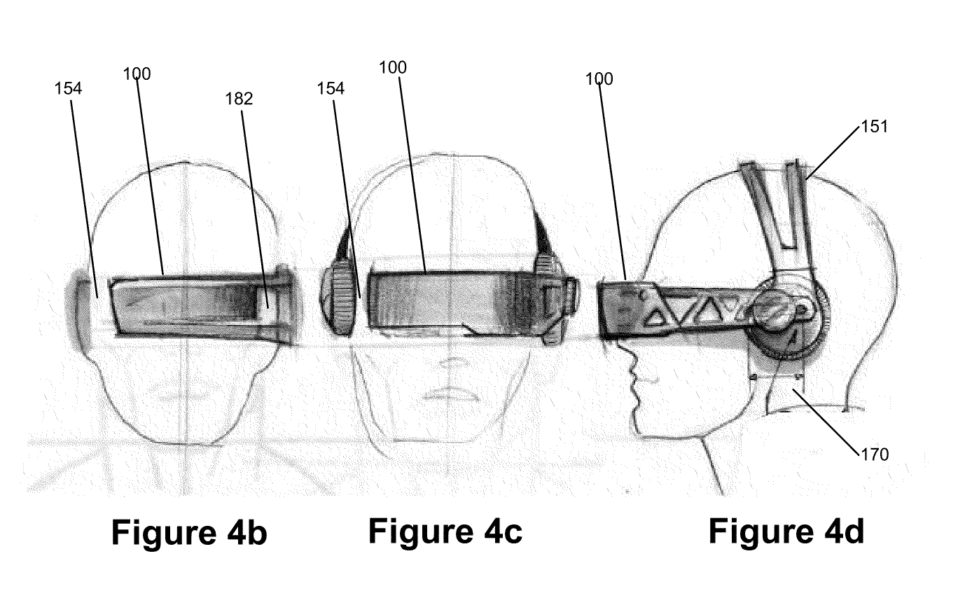

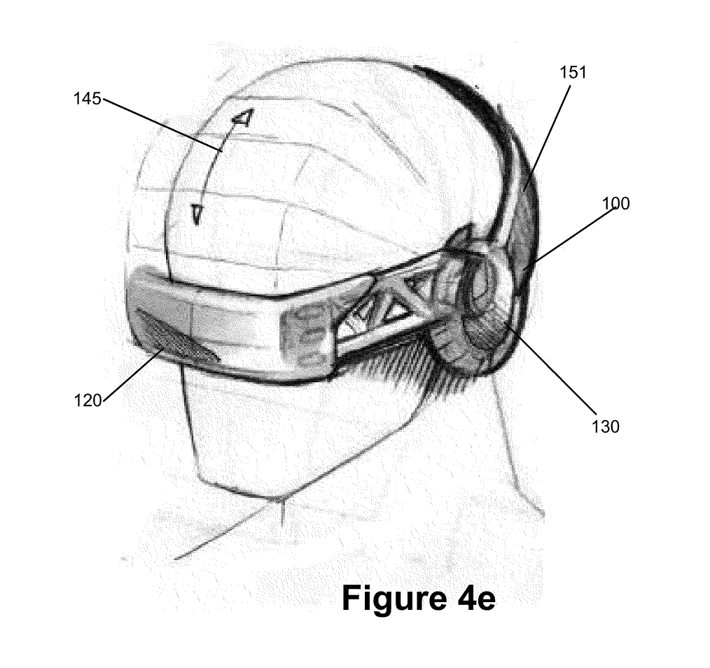

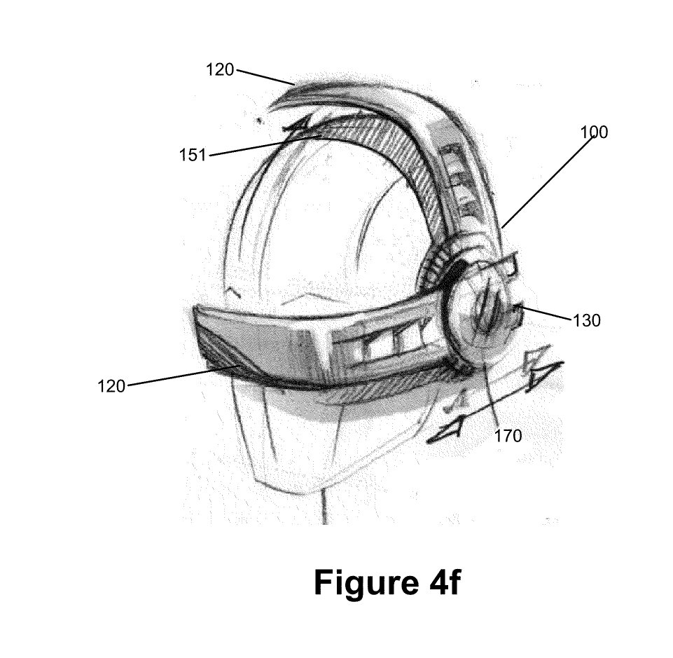

The apparatus 100 was originally conceptualized as a conventional set of headphones with a moveable display 120 such as the apparatus 100 illustrated in FIG. 1 b. However, the apparatus 100 can be implemented in any type of headgear configuration capable of supporting the functionality of a display 120 and one or more speakers 130. Different headphone embodiments are illustrated in FIGS. 1 b, 1c, 4a-4f, and 5a-5c. As illustrated in FIG. 4e, the apparatus 100 can include a compression-based headband 151, although other types of headbands 150 can be also be used. Headbands 150 are typically rigid or semi-rigid, but highly flexible elastic headbands 150 can also be used, both with respect to the speakers 130 such as a cushioned earphone 131 and other alternative variations. As illustrated in FIGS. 1 b and 1 c, motion of the display 130 can coincide with the transition of the apparatus 100 from an audio-only mode 111 (display 130 positioned above the head 101 of the user 102) to an audio-visual mode 113 (display 130 positioned in front of the eyes of the user 102).

b. Baseball Cap Embodiments

The apparatus 100 can also be embodied in the form of a baseball cap. In some baseball cap embodiments, the bill of the cap is the display 120, and users 102 can switch to the audio-visual mode 113 by flipping the display 120 downwards. In other embodiments, the bill can provide a structural anchor about which the display 120 can fold down from the top or bottom surface of the bill. Still other embodiments, the mechanisms for supporting the display 120 can be totally unrelated to the bill of the cap.

c. Glasses/Goggles Embodiments

The apparatus 100 can be embodied in glasses or goggles. One or more speakers 130 could be built in to the applicable glasses or goggles, or more conventional ear pieces could be used as speakers 130, with the display 120 and speakers 130 functioning as an integrated unit.

d. Helmet Embodiments

One challenge with respect to many embodiments of the apparatus 100 is to make the apparatus 100 as non-obtrusive as possible. This goal is a primarily matter of ascetics. Thus some embodiments may utilize more obtrusive helmet structures to securely position the display 120 and the one or more speakers 130. This can be particularly useful when the apparatus is intended to be used in more harsh environmental conditions, such as on a construction site. There are after all many industrial settings in which the ability to view media is not a form of entertainment.

e. Other Headgear Embodiments

Virtually any form of headgear capable of supporting a display 120 and one or more speaker 130 can serve as the integrative element for the apparatus 100. As technology advances, the capacity to make small and lighter displays 120 and speakers 130 will also continue to advance.

f. Hybrid Embodiments

Different aspects of the various embodiments discussed above can be mixed and matched together. For example, a display 120 in the form of glasses or goggles could be combined with headphones, baseball cap, or a helmet.

2. Components

The apparatus 100 can be implemented with a wide variety of different components utilizing a wide variety of different component configurations.

a. Display

A display 120 is typically a screen that is used to provide users 102 with access to visual components 117 of media content units 104. A wide range of technologies can be incorporated into one or more displays 120 included within the apparatus 100. Examples of display technologies include but are not limited to plasma screens, LCD screens, LED screens, and virtually any other type of visual communication technology that can be either permanently or temporarily mounted within the apparatus 100 in a secure manner. Displays 120 can involve a wide variety of different functionality attributes such as 3-D, high definition, and other features known in the prior art.

Among the types of potential displays include a visual retina display 121 (see FIG. 2) that can be utilize micro-mirrors relying on a combination of optics and a micro-mirror array to project an image directly onto the retina of the user 102. Such images will be immersive and stereoscopic, providing a full 3D effect.

In some embodiments of the apparatus 100, the display 120 can include a cover 122 that protects the display 120 when it is not in use. In some embodiments of the apparatus 100, the display 120 is moveable to various positions depending on an operating mode 109 relating to the apparatus 100. As illustrated in FIG. 1 c, the display of the apparatus 100 can be located in a position 145 in front of the eyes of the user 102 when the apparatus 100 is in an audio-visual mode 113 or a visual-only mode 115, while being in a different position 145 above the head of the user 102 when the apparatus 100 is in an audio-only mode 111. In some embodiments, movement of the display 120 from one position 145 to another position 145 is the trigger for the change in operating modes 109. In other embodiments, that movement is the result of a change in operating modes 109. In still other embodiments, such movement from one position 145 to another position 145 can be unrelated to changes in operating modes 109.

b. Speaker

Returning to FIG. 1a, the apparatus 100 can include a speaker 130 or a configuration of multiple speakers 130. The speaker 130 is a component or assembly of components such as an electro-acoustic device that is used to access the audio component 116 of the media content unit 104. A wide range of technologies can be incorporated into the one or more speakers 130 utilized by the apparatus 100. For example, surround sound and other technologies can be used to provide users 102 with a high quality audio experience. In many embodiments, the speakers 130 can include a cushioned earpiece 131.

3. Operating Modes

The apparatus 100 can possess a variety of different operating modes 109 that relate to the type of media content units 104 being accessed by the user 102.

a. Audio-Only Mode

An audio-only mode 111 is an operating mode 109 in which the media content unit 104 is an audio-only content unit 110. In many embodiments of the apparatus 100, the display 120 of the apparatus 100 will be in a position 145 that does not block the eyes of the user 102 while the apparatus 100 is in this mode 109.

b. Audio-Visual Mode

An audio-visual mode 113 is an operating mode 109 in which the media content unit 104 is an audio-visual content unit 112. In many embodiments of the apparatus 100, the display 120 is positioned in front of the eyes of the user 102 when the apparatus is in this mode

c. Visual-Only Mode

An operating mode 109 in which the media content unit 104 is a visual-only content unit 114.

4. Process Flow View

The apparatus 100 can be described as a process performed by a user 102. FIG. 1 d is a method of accessing media content units 104 through a wearable apparatus 100 that can operate in multiple operating modes 109.

At 200, the user 102 accesses a media content unit 104 through the apparatus 100. In some instances, the apparatus 100 receives information over a connection 164 (either wired 168 or wireless 166) to a media player. In other instances, the apparatus 100 is itself the media player.

At 202, the user 102 changes the operating mode 109 of the apparatus 100.

At 204, the user 102 can then access a media content unit 104 of a different type than the type accessed at 200. So for example, the user 102 could switch from an audio-only mode 111 to an audio-visual mode 113 or vice versa.

5. User Controls

Some embodiments of the apparatus 100 will include a user control 140. A user control 140 is potentially any mechanism or process by which a user 102 can impact or configure the functionality of the apparatus 100. As illustrated in FIG. 1e, a user control 140 can be used to make an adjustment 170 to the functionality of the apparatus. User controls 140 can also be used to transition the apparatus 100 from one operating mode 109 to another operating mode 109. Examples of user controls 140 include buttons, knobs, dials, touch screens, microphones 146 coupled with voice recognition technology, sensors that can capture attributes relating to the user 102, the relative motion of different components of the apparatus 100, or virtually any other technique for triggering an “instruction” from the user 102 to the apparatus 100.

As illustrated in FIG. 1e, there are several different technologies on which a user control 140 can be based.

a. Mechanical Control

A mechanical control 141 is a user control 140 that functions through the mechanical means and the operation of mechanical and structural properties.

b. Electro-Mechanical Control

An electro-mechanical control 142 is a user control 140 that functions through the operation of both mechanical means and electrical means.

c. Electrical Control

An electrical control 143 is a user 140 that functions through the operation of electrical means.

d. Virtual Control

A virtual control 144 is a user control 140 that functions through the operation of information technology, typically through some type graphical user interface.

### II. ALTERNATIVE EMBODIMENTS

No patent application can expressly disclose in words or in drawings, all of the potential embodiments of an invention. In accordance with the provisions of the patent statutes, the principles and modes of operation of the apparatus 100 are explained and illustrated in certain preferred embodiments. However, it must be understood that the apparatus 100 may be practiced otherwise than is specifically explained and illustrated without departing from its spirit or scope.

The description of the apparatus 100 provided above and below should be understood to include all novel and non-obvious alternative combinations of the elements described herein, and claims may be presented in this or a later application to any novel non-obvious combination of these elements. Moreover, the foregoing embodiments are illustrative, and no single feature or element is essential to all possible combinations that may be claimed in this or a later application. The capability of modifying images in accordance with a right/left differential can be implemented using a wide variety of different technologies and components.

### III. OPTIONAL COMPONENT AND CONFIGURATION OPTIONS

The apparatus 100 can be implemented in wide variety of different configurations utilizing a wide variety of different components. FIG. 2 is a block diagram illustrating an example of other components that can be incorporated into the apparatus 100. The visual retinal display 121 and cover 122 are discussed above with respect to displays 120. The cushioned earpiece or cushioned headphone 131 is discussed above with respect to speakers 130. Microphones 146 are discussed above with respect to user controls 140. Headbands 150 and compression-based headbands 151 are discussed above with respect to the different embodiments of the apparatus 100.

A. Adjustments

In different embodiments of the apparatus 100, the user 102 will be able to customize the apparatus 100 to different degrees. The capability of making adjustments 170 can be important with respect to the comfort of the user 102 as well as to maximizing the ability of users 102 to benefit from the apparatus 100. FIG. 3 is a hierarchy diagram illustrating examples of the different categories and subcategories of adjustments 175.

1. Visual Settings Adjustment

A visual settings adjustment 176 is an adjustment to the display of visual content on the display 120. Examples of visual settings include contrast, brightness, and other attributes known in the art in the context of monitors and television sets. Visual settings also include certain attributes that are not included in prior art television screens. Visual settings adjustments 176 can be made manually by a user 102 utilizing a user control 140, or automatically by the apparatus 100 itself.

a. Eye Relief Adjustment

An eye relief adjustment 171 is an adjustment 170 made to reduce the eye strain of the user 102. Eye strain adjustments 171 can include functions such as modifying contrast, brightness, the focus of an image, the size of the image, and other functions.

b. Interpupillary Distance Adjustment

An interpupillary distance adjustment 172 is an adjustment 170 of the distance between the centers of the two pupils of the user 102. The distance between the two eyepieces of the binocular viewing display 120 should correspond to interpupillary distance for that particular user 102.

c. Diopter Adjustment

A diopter adjustment 173 is an adjustment to the image in the display 120 to match the eyesight of the user 102.

2. Audio Settings Adjustment

An audio settings adjustment 177 can include potentially any adjustment that one can make with respect to the production of sound. Base, treble, and other types of audio adjustments 177 known in the art can be incorporated into the apparatus 100.

3. Positioning Settings Adjustment

A positioning settings adjustment 178 is an adjustment 170 that relates to the positioning of the apparatus 100 on the user 102, and not the ways in which media content units 104 are accessed by the user 102. One category of positioning settings adjustments 178 is a compression level adjustment 174 in a compression-based headband 151.

B. Fold

A fold 153 is a structural element of the apparatus 100, typically found in a headband 150 embodiment of the apparatus 100. A fold 153 can be a useful way to prevent some type of sliding mechanism from going beyond a certain point.

C. Break

A break 154 is a structural element of an apparatus 100. An example of a break 154 is illustrated in FIGS. 4b and 4b.

D. Hinge

A hinge 155 is an element of the apparatus 100 that permits movement of a component with respect to other components or with respect to the apparatus 100 as a whole. Hinges 155 can facilitate a change in position 145 as part of a change in operating mode 109 and/or be part of an adjustment 170.

E. Rails

A rail 156 is an element of the apparatus 100 that like the hinge, permits movement of a component relative to other components and/or the apparatus 100 as a whole. This can be part of an adjustment 170 and/or a change in the operating mode 109 of the apparatus 100.

F. Springs

A spring 157 is a compression-based element that like the hinge 155 or rail 156, can facilitate adjustments 170 and/or changes in operating modes 109.

G. Computer Processor

A computer processor 160 is potentially any machine that is capable of running instructions in the form of computer programs. Some embodiments of the apparatus 100 will not have a computer processor 160. Other embodiments may have highly special programmable logic devices. Still other embodiments can include general purpose computer devices as computer processors 160.

H. Memory Component

A memory component 162 can be used to store various adjustments 170 and other settings, profiles associated with specific users 102, and potentially media content units 104.

I. Peripheral Views

Many embodiments of the apparatus 100 will involve a display 120 positioned directly in front of the eyes of a user 102 when the apparatus 100 is in a mode of operation 109 that includes the accessing of visual content. Such an apparatus 100 can include peripheral views 180, both vertically 181 and horizontally 182 so that the user 102 is not totally cut off from the outside world when accessing visual content.

J. Connections

A connection 168 is potentially any technological infrastructure or configuration that supports the exchange of information from one component to another of the apparatus 100, or between the apparatus 100 and the outside world. A connection 164 can be a wired connection 168 or a wireless connection 166.

### IV. HEADBAND EMBODIMENTS

As discussed above, the apparatus 100 was originally conceived of in the context of a headband 150 embodiment.

FIG. 1 b is environmental view illustrating an example of a front view of a user 102 wearing an embodiment of the apparatus 100. This drawing illustrates an example of locations within the apparatus 100 that provide a sideways peripheral view 182 and a vertical (downwards) peripheral view 181. This embodiment of the apparatus 100 does not involve a break between either speaker 130 and the display 120 (contrast with FIG. 4b and FIG. 4c). Each speaker 130 is thus adjacent to a rotating component 152 to facilitate a change in the operating mode 109 of the apparatus 100.

FIG. 1 c is an environmental view illustrating an example of a perspective view of a user 102 wearing an embodiment of the apparatus 100. This drawing illustrates two distinct positions 145 of the display 120 that relate to two different operating modes 109.

FIG. 4a is an environmental diagram illustrating an example of a side view of a user 102 wearing an embodiment of the apparatus 100. This embodiment includes a rotating component 152 with a restraining knob that constrains the maximum rotation of the rotating component 152.

FIG. 4b is an environmental diagram illustrating an example of a front view of a user 102 wearing an embodiment of the apparatus 100 that includes a display 120 that is only attached to the apparatus 100 on one side (i.e. includes a break 154).

FIG. 4c is an environmental diagram illustrating an example of a perspective view of a user 102 wearing an embodiment of the apparatus 100 that includes a display 120 that is only attached to the apparatus 100 on one side.

FIG. 4d is an environmental diagram illustrating an example of a side view of a user 102 wearing an embodiment of the apparatus 100 that includes a display 120 that is only attached to the apparatus 100 on one side. An example of an adjustment 170 (more specifically a positioning adjustment 178) is also disclosed in the figure.

FIG. 4e is an environmental diagram illustrating an example of a perspective view of a user 102 wearing an embodiment of the apparatus 100 that allows the display 120 to be rotated upwards when the apparatus 100 is not displaying visual content.

FIG. 4f is an environmental diagram illustrating an example of a perspective view of a user 102 wearing an embodiment of the apparatus 100 with the display 120 in a position that does not block the eyes of the user 102.

### V. COMPONENT/SUB-ASSEMBLY VIEWS

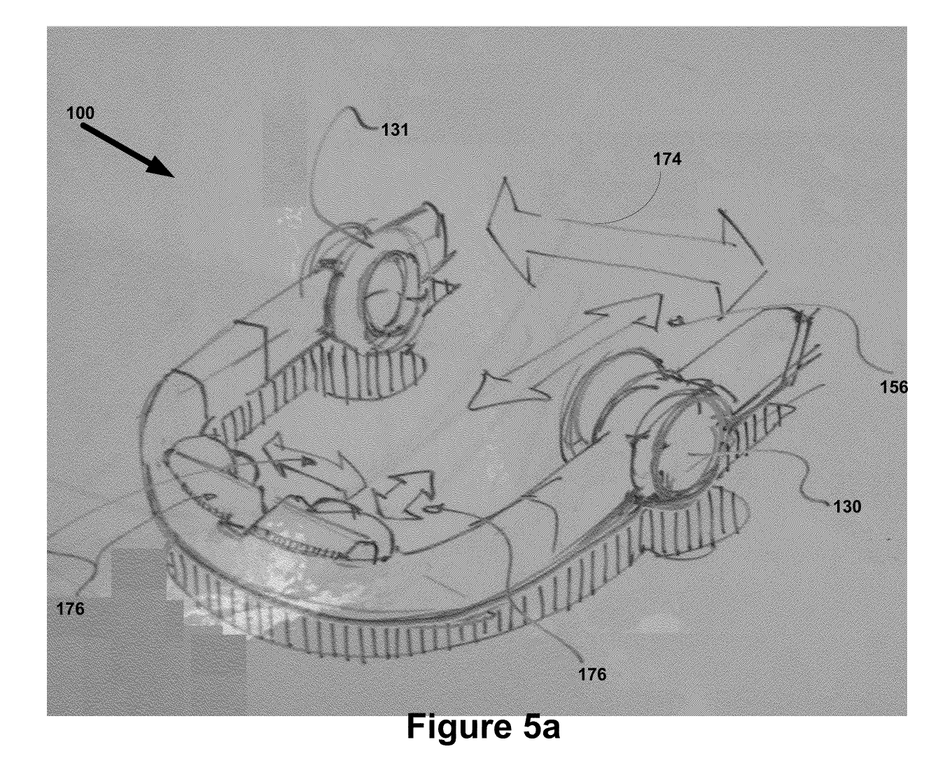

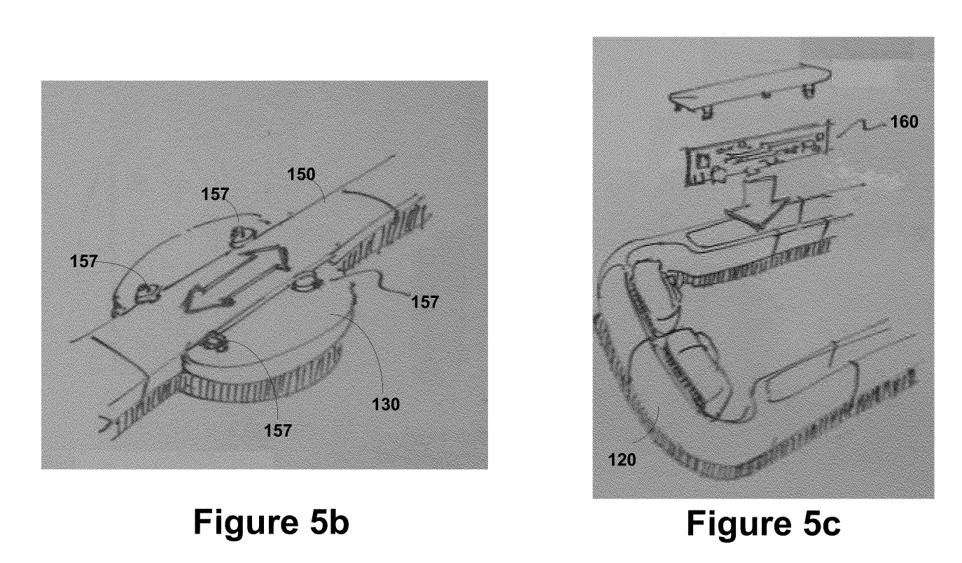

FIG. 5a is a diagram illustrating a perspective view of different components of the apparatus 100, including various adjustments 170 that can be made to the apparatus 100. The speakers 130 can slide on rails 156. Each speaker 130 can be wrapped in cushioned leather 131. The ability to empower users 102 with various adjustments 170 of all types are implemented into to the headband 150.

FIG. 5b is a diagram illustrating a perspective view of springs 157 allowing a speaker 130 to move along a headband 150

FIG. 5c is a diagram illustrating a perspective view of certain components of the apparatus 100, such a stereoscopic display 120 and a computer processor 160.

### VI. PROCESS FLOW VIEWS

A. Alternative #1

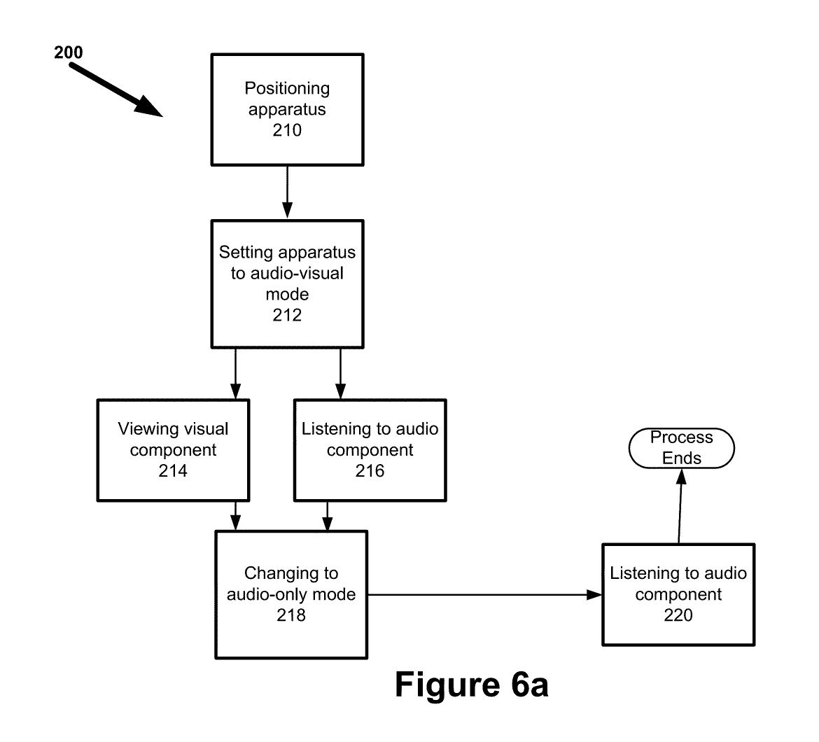

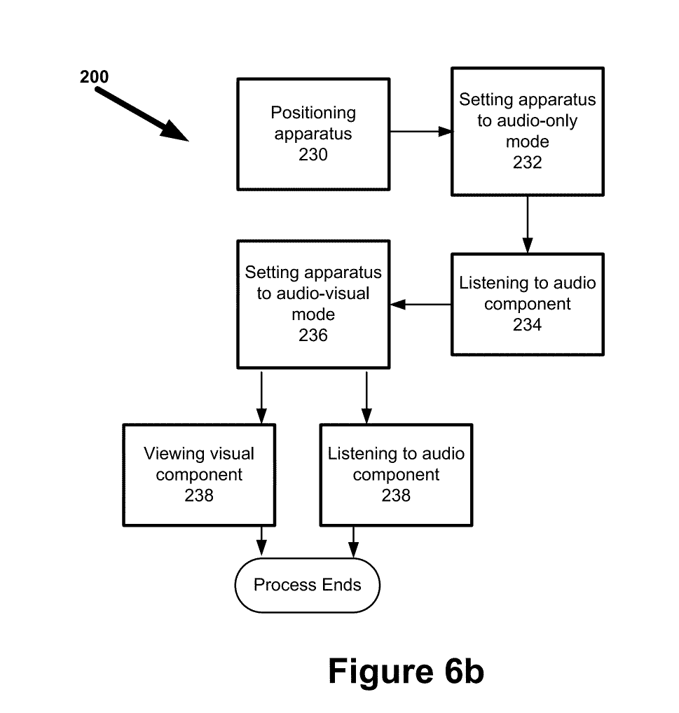

FIG. 6a is a process flow diagram illustrating a method 200 for accessing media content units 104. In the example, a user 102 accessing media content first in an audio-visual mode 113 and then in an audio-only mode 111.

At 210 the apparatus 100 is positioned on the head 101 of the user 102.

At 212, the apparatus 100 is set to an audio-visual mode 113.

At 214 the visual component 117 is accessed by the user 102 in a simultaneous or substantially simultaneous manner with the accessing at 216 of the audio component 116.

At 218, the apparatus 100 is transitioned to an audio-only mode 111.

At 218, the apparatus 100 is used to access the audio component 116 without any visual component 117 being accessed by the apparatus 100.

A. Alternative #2

FIG. 6b is a process flow diagram illustrating an example of a user 102 accessing media content first in an audio-only mode 111 and then in an audio-visual mode 113. The only difference between this process and the process in FIG. 6a is the order of the operating modes 109 in the example.

### VI. INDEX

The claim elements are listed and described in the index provided below as Table 1.

TABLE 1

| Element | Element | Element |
|---|---|---|
| Number | Name | Description |
| 100 | Apparatus | A device that allows a user 102 to access media |
| | | content units 104 in a variety of different operating |
| | | modes 109. A wide variety of different components |
| | | and techniques can be used to facilitate the secure |
| | | positioning of the apparatus 100 on the head 101 of a |
| | | user 102. The apparatus 100 can be implemented in |
| | | a wide variety of different configurations. |
| 101 | Head | A portion of the user 102 comprising the eyes (visual |
| | | sensors) and ears (acoustic sensors) of the user 102. |
| 102 | User | Typically a human being. However, the apparatus |
| | | 100 can be implemented in ways that could be useful |
| | | to other types of mammals and potentially even |
| | | robots. |
| 104 | Content Unit | A unit or grouping of units of media content. A media |
| | | content 104 can be comprised of a short clip lasting a |
| | | mere second, or a comprehensive anthology of |
| | | content or works Examples of media content units |
| | | can include songs, music albums, entire collections of |
| | | albums, movies, movie collections, television |
| | | episodes, television series, audio clips, video clips, |
| | | slide shows, power point presentations, newspaper |
| | | articles, books, individual images, and other types of |
| | | content that include either some type of audio |
| | | component 116 and/or some type of visual |
| | | component 117. |
| 109 | Operating Mode | The operating modes 109 of the apparatus 100 relate |
| | | to the types of media content units 104 being |
| | | accessed. Examples of different operating modes |
| | | 109 include an audio-only mode 111, an audio-visual |
| | | mode 113, and a visual-only mode 115. |
| 110 | Audio-Only | A media content unit 104 that includes an audio |
| | Content Unit | component 116 but no visual component 117. |
| 111 | Audio-Only Mode | An operating mode 109 in which the media being |
| | | accessed is an audio-only content unit 110. |
| 112 | Audio-Visual | A media content unit 104 that includes an audio |
| | Content Unit | component 116 and a visual component 117. |
| 113 | Audio-Visual | An operating mode 109 in which the media being |
| | Mode | accessed is an audio-visual content unit 112. |
| 114 | Visual-Only | A media content unit 104 that includes a visual |
| | Content Unit | component 117 but no audio component 116. |
| 115 | Visual-Only Mode | An operating mode 109 in which the media being |
| | | accessed is an visual-only content unit 114. |
| 116 | Audio Component | The component of a media content unit 104 that |
| | | involves the sense of sound. |
| 117 | Visual | The component of a media content unit 104 that |
| | Component | involves the sense of sight. It is anticipated that many |
| | | embodiments of the apparatus 100 will video |
| | | components 118 but the apparatus 100 can also be |
| | | used to view still frame images or sequences of still |
| | | frame images for which the user 102 is prompted to |
| | | move to the next image in the sequence. |
| 118 | Video Component | A visual component 118 is a visual component 117 |
| | | that involves a series of images played for the user |
| | | 102 at a predefined rate without waiting for prompting |
| | | by the user 102. |
| 120 | Display | A component or assembly such as a screen that is |
| | | used to access the visual component 117 of a media |
| | | content unit 104. A wide range of technologies can |
| | | be incorporated into the display 120. Examples of |
| | | displays 120 include but are not limited to: plasma |
| | | screens, LCD screens, LED screens, and virtually any |
| | | other type of visual communication technology that |
| | | can be mounted onto the apparatus 100. Displays |
| | | 120 can also involve a wide variety of different |
| | | functionality attributes such as 3-D, high definition, |
| | | etc. |
| 121 | Virtual Retinal | A virtual retinal display 121 is a type of display 120 |
| | Display | that projects the visual component 117 of the content |
| | | unit 104 directly onto the eye of the user 102. |
| 122 | Cover | A component of the apparatus 100 that can be used |
| | | to protect the display 120 when the apparatus 100 is |
| | | not in use, or when the apparatus 100 is operating in |
| | | an audio-only mode 111. In some embodiments, the |
| | | cover 122 is a flexible or substantially flexible sheath. |
| | | In other embodiments, the cover 122 can be a rigid or |
| | | substantially rigid component. Some covers 122 can |
| | | be designed to be permanently attached to the |
| | | apparatus 100 while other embodiments of the cover |
| | | 122 will provide for being physically separated from |
| | | the apparatus 100. |
| 130 | Speaker | A component or assembly such as an electroacoustic |
| | | device that is used to access the acoustic component |
| | | 116 of a media content unit 104. A wide range of |
| | | technologies can be incorporated into the one or |
| | | more speakers 130 incorporated into the apparatus |
| | | 100. |
| 131 | Cushioned | In some embodiments of the apparatus 100, the |
| | Headphone | speakers 130 are in the form of cushioned |
| | | headphone speakers 131. |
| 140 | User Control | A mechanism by which the user 102 can impact the |
| | | functionality of the apparatus 100. User controls 140 |
| | | can also be used to change the operating mode 109 |
| | | of the apparatus 100. Examples of user controls 140 |
| | | include buttons, knobs, dials, touch screens, |
| | | microphones 146 coupled with voice recognition |
| | | technology, sensors that can capture attributes |
| | | relating to the user 102, the relative motion of |
| | | different components of the apparatus 100, or virtually |
| | | any other technique for triggering an “instruction” from |
| | | the user 102 to the apparatus 100. |
| 141 | Mechanical | A user control 140 that operates through mechanical |
| | Control | means. |
| 142 | Electro- | A user control 140 that operates through electro- |
| | Mechanical | mechanical means. |
| | Control | |
| 143 | Electrical Control | A user control 140 that operates through electronics |
| | | means. |
| 144 | Virtual Control | A user control 140 that operates through a |
| | | virtualization of an information technology |
| | | environment, such as a selection made from a menu |
| | | on a graphical user interface. |
| 145 | Position | A location relative to other components of the |
| | | apparatus 100. In some embodiments of the |
| | | apparatus 100, movement of a component from one |
| | | position to another position is a form of user control |
| | | 140. By way of example, in some embodiments, |
| | | movement of a display 130 can be associated with |
| | | one position for engaging in visual content 117 and |
| | | another position for engaging in audio content 116 in |
| | | which the display 130 is disabled. |
| 146 | Microphone | A sensor component of the apparatus 100 that can |
| | | capture acoustic attributes from the user 102 and/or |
| | | the environment surrounding the user 102. |
| 150 | Headband | A mechanism that secures the position of the speaker |
| | | 130 with respect to the display 120. The apparatus |
| | | 100 can incorporate a wide range of different |
| | | headbands 150 with a wide range of different |
| | | attributes. |
| 151 | Compression- | A headband 150 that uses compression technology |
| | Based Headband | not tension technology to securely position the |
| | | apparatus on the head 101 of the user 102. |
| 152 | Rotating | A component of the apparatus 100 that can allow one |
| | Component | component to rotate with respect to other components |
| | | of the apparatus 100. For example, the display 120 |
| | | can be coupled with a rotating component 152 to |
| | | permit the display to rotate between an engaged |
| | | position for viewing visual components 117 and a |
| | | disabled position for viewing audio-only content units |
| | | 110. |
| 153 | Fold | A component of a headband 150 or other structure |
| | | within the apparatus 100. A fold 153 can be used to |
| | | help secure the position of the apparatus 100 on the |
| | | user 102. |
| 154 | Break | A component of a headband 150 or other structure |
| | | within the apparatus 100. A break 154 can be used |
| | | to help secure the position of the apparatus 100 on |
| | | the user 102. |
| 155 | Hinge | A component of a headband 150 or other structure |
| | | within the apparatus 100. A hinge 155 can be used to |
| | | help secure the position of the apparatus 100 on the |
| | | user 102. |
| 156 | Rails | A component of a headband 150 or other structure |
| | | within the apparatus 100 that can be used to facilitate |
| | | the movement of a component of the apparatus 100. |
| | | For example, the speaker(s) 130 or display 120 can |
| | | be designed to roll on rails 156. |
| 157 | Springs | A component of the apparatus 100 that can either be |
| | | used to help secure the position of the apparatus 100 |
| | | with respect to the user 102 or a component of the |
| | | apparatus 100 with respect to the other components |
| | | of the apparatus 100. |
| 160 | Computer | An information technology component capable of |
| | Processor | executing programming instructions. The apparatus |
| | | 100 can utilize a wide variety of different computer |
| | | processors 160. |
| 162 | Memory | An information technology component capable of |
| | Component | storing information such as media content units 104 |
| | | and instructions or preferences from users 102 such |
| | | that the stored information can later be retrieved by |
| | | the computer processor 160. |
| 164 | Connections | An information pathway between two components of |
| | | the apparatus 100 or between the apparatus 100 and |
| | | a device outside the apparatus 100. |
| 166 | Wireless | A connection 164 that operates through a wire. |
| | Connections | |
| 168 | Wired | A connection 166 that operates without the presence |
| | Connections | of a wire. |
| 170 | Adjustments | An adjustment 170 is virtually any change in the |
| | | processing, performance, configuration, or use of the |
| | | apparatus 100 that can be initiated by a user 102, |
| | | whether directly or indirectly. |
| 171 | Eye relief | An adjustment for providing eye relief to the user 102. |
| | adjustment | |
| 172 | Interpupillary | An adjustment for improving the interpupillary |
| | distance | distance for the user 102. |
| | adjustment | |
| 173 | Diopter | An adjustment for the diopter of the user 102. |
| | adjustment | |
| 174 | Compression | An adjustment relating to the compression used to |
| | level adjustment | securely position the apparatus 100 on the user 102. |
| 175 | Volume | An adjustment relating to the volume at which the |
| | adjustment | user 102 experiences audio components 116 through |
| | | a speaker 130. |
| 176 | Visual settings | An adjustment that relates to how visual components |
| | adjustment | 117 are experienced by the user 102. |
| 177 | Audio settings | An adjustment that relates to how audio components |
| | adjustment | 116 are experienced by the user 102. Acoustic |
| | | settings adjustments 177 can also be referred to as |
| | | audio setting adjustments 177 |
| 178 | Positioning | An adjustment that relates to the positioning of the |
| | settings | apparatus 100 on the user 102. |
| | adjustment | |
| 180 | Peripheral views | A view of a user 102 wearing the apparatus 100 that |
| | | is unblocked by the display 120. |
| 181 | Downward | A view of a user 102 looking below the display 120 of |
| | peripheral view | the apparatus 100. |
| 182 | Sideways | A view of a user 102 looking to either side of the |
| | peripheral view | display 120 of the apparatus 100. |

1. An apparatus that provides for being positioned on the head of a user while playing an audio-only content unit in an audio-only mode and an audio-visual content unit in an audio-visual operating mode, said comprising:
a plurality of operating modes, said plurality of operating modes including said audio-only mode and said audio-visual mode;
a display, said display providing for playing a visual component of the audio-visual content unit when said apparatus is in said audio-visual mode; and
a speaker, said speaker providing for playing an audio component of the audio-visual content unit when said apparatus is in said audio-visual mode, and said speaker providing for playing said audio-only content unit when said apparatus is in said audio-only mode.

2. The apparatus of claim 1, wherein said display is disabled when said apparatus is in said audio-only mode, and wherein changing from said audio-only mode to said audio-visual mode includes moving said display from a first position to a second position.

3. The apparatus of claim 1, said apparatus further comprising a headband connecting said display to said speaker.

4. The apparatus of claim 1, said apparatus further comprising a user control providing for switching between said audio-only mode and said audio-visual mode.

5. The apparatus of claim 1, wherein said display provides for directly displaying said visual component of said audio-visual content unit as a virtual retinal display.

6. The apparatus of claim 1, wherein said plurality of operating modes includes a visual-only mode.

7. The apparatus of claim 1, said apparatus further comprising a computer processor and a memory component, wherein said memory component provides for storing said audio-visual content unit and said audio-only content unit.

8. The apparatus of claim 1, wherein said apparatus is at least substantially rigid and does not include a rotating component.

9. The apparatus of claim 1, said apparatus further comprising a microphone.

10. The apparatus of claim 1, wherein said display rotates around said speaker.

11. The apparatus of claim 1, said apparatus further comprising a cover that provides for covering said display when said display is not in use.

12. The apparatus of claim 1, said apparatus further comprising a plurality of user controls that provide for an eye relief adjustment, an interpupillary distance adjustment, and a diopter adjustment.

13. The apparatus of claim 1, said apparatus further comprising a compression-based headband.

14. The apparatus of claim 13, said apparatus further comprising a user control for modifying a compression level adjustment for said compression-based headband.

15. The apparatus of claim 1, wherein said display provides for being moved when raised, and wherein said display is temporarily disabled when said display is raised.

16. The apparatus of claim 1, wherein said display provides for at least one of: (a) an unobstructed peripheral view in a downward direction; and (b) an unobstructed peripheral view in a sideways/lateral direction.

17. The apparatus of claim 1, wherein said apparatus does not include: (a) a fold; (b) a break; and (c) a hinge.

18. The apparatus of claim 1, wherein said apparatus includes a plurality of wireless connections.

19. A apparatus that provides for the playing of an audio-only content unit in an audio-only mode and an audio-visual content unit in an audio-visual mode while being positioned on the head of a human being, said apparatus comprising:
a plurality of operating modes, said plurality of operating modes including said audio-only mode and said audio-visual mode;
a display, said display providing for playing a visual component of the audio-visual content unit when said apparatus is in said audio-visual mode, and wherein said display is disabled when said apparatus is in said audio-only mode;
a plurality of speakers, said plurality of speakers providing for playing an audio component of the audio-visual content unit when said apparatus is in said audio-visual mode, and said plurality of speakers providing for playing said audio-only content unit when said apparatus is in said audio-only mode;
a headband that is at least substantially rigid, said headband providing for connecting said display to said plurality of speakers; and
a plurality of user controls, wherein said plurality of user controls provide for switching between said plurality of operating modes, changing a volume adjustment for said plurality of speakers, and changing a plurality of visual settings relating to said display.

20. A method for a user to access an audio-only content unit and an audio-visual content unit using an apparatus positioned on the head of a human being, said method comprising:
positioning the apparatus on the head of the human being;
setting the apparatus to the audio-visual mode using one or more user controls on the apparatus;
viewing a visual component of the audio-visual content unit through a display attached to the apparatus while listening to an audio component of the audio-visual content unit through a speaker attached to the apparatus while the visual component is viewed through the display;
changing the apparatus to the audio-only mode using one or more user controls on the apparatus; and
listening to the audio-only content unit through a speaker attached to the apparatus.
